(19) United States
(12) Patent Application Publication
(10) Pub. No.: US 2025/0140986 A1
(43) Pub. Date: May 1, 2025

(54) BATTERY SYSTEM AND INSULATOR FOR A BATTERY SYSTEM

(71) Applicant: Terex South Dakota, Inc., Watertown, SD (US)

(72) Inventors: Kai WANG, Jiangsu (CN); Wei YANG, Jiangsu (CN); Ling ZHANG, Jiangsu (CN); Zachary FUNG, Redmond, WA (US)

(73) Assignee: Terex South Dakota, Inc., Watertown, SD (US)

(21) Appl. No.: 18/497,317

(22) Filed: Oct. 30, 2023

(51) Int. Cl. H01M 10/658; H01M 10/647; H01M 50/209; H01M 50/291; H01M 50/293; H01M 50/383

(52) U.S. Cl. CPC H01M 10/658; H01M 10/647; H01M 50/209; H01M 50/291; H01M 50/293; H01M 50/383

(57) ABSTRACT

A battery system includes multiple battery cells each having a cell vent configured to vent flames originating from the battery cell in the event of a thermal runaway condition of the battery cell, and an insulator disposed adjacent a first battery cell, wherein the insulator comprises a hinged element configured to align with the cell vent of the first battery cell. In a closed position, the hinged element provides insulation for the first battery cell, and in an open position, the hinged element provides a vent to enable flames venting from the cell vent of the first battery cell to escape from between the insulator and the first battery cell to thereby inhibit the flames venting from the cell vent of the first battery cell from reaching a second battery cell.

### TECHNICAL FIELD

The following relates to a battery system and an insulator for a battery system.

### BRIEF DESCRIPTION OF THE DRAWINGS

FIGS. 1A and 1B are perspective views of a non-limiting exemplary embodiment of a battery system according to the present disclosure;

FIGS. 2A and 2B are partial side and partial exploded perspective views of a non-limiting exemplary embodiment of a battery system according to the present disclosure;

FIGS. 3A and 3B are perspective and cross-sectional views of a non-limiting exemplary embodiment of an insulator for a battery system according to the present disclosure; and

FIG. 4 is a side view of a non-limiting exemplary embodiment of an insulator for a battery system according to the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

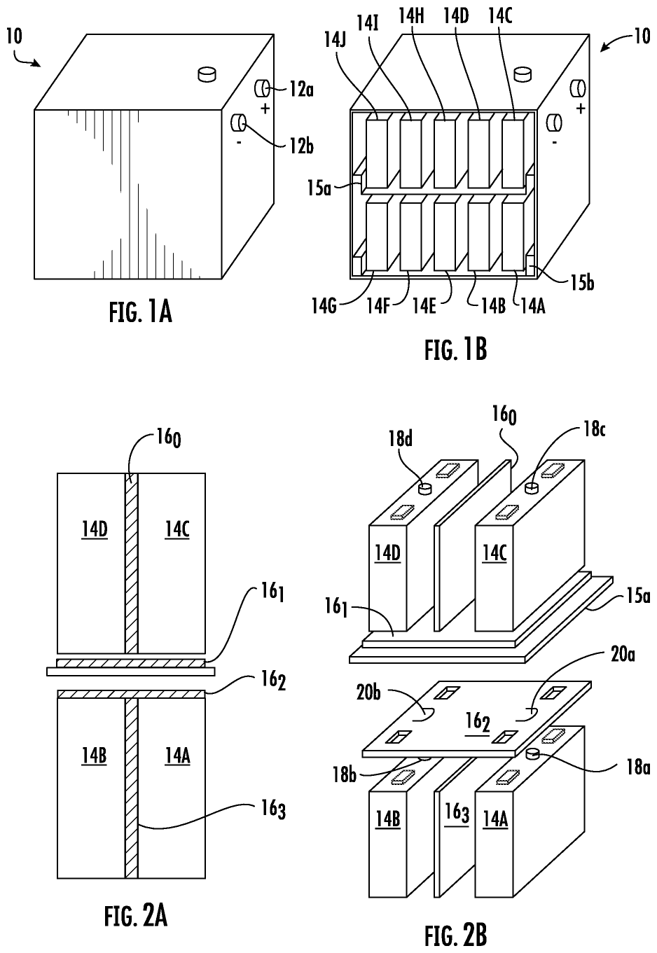

FIGS. 1A and 1B are perspective views of a non-limiting exemplary embodiment of a battery system according to the present disclosure. As seen therein, the battery system 10 may include positive and negative terminals 12a, 12b on one side thereof. As seen in FIG. 1B, in which a side panel of the battery system 10 has been omitted, the battery system 10 (which may also be referred to as a battery pack, a battery module, a battery cell module, or the like) may comprise a plurality of battery cells 14A-14J which may be provided in electrical communication and arranged in upper and lower horizontal rows inside the battery system 10, with each row of battery cells 14A-14J supported by a structure 15a, 15b of the battery system 10.

FIGS. 2A and 2B are partial side and partial exploded perspective views of a non-limiting exemplary embodiment of the battery system 10 of FIG. 1B according to the present disclosure. As seen therein, insulators 16₀, 16₁, 16₂, 16₃ may be positioned, provided, located, or interposed between individual battery cells 14A and 14B in the lower horizontal row, between individual battery cells 14C and 14D in the upper horizontal row, and/or between the lower (14A, 14B) and upper (14C, 14D) horizontal rows of battery cells 14A-14D. As seen in FIG. 2B, each of the battery cells 14A-14D may include a cell vent 18a-18d, which may be located between positive and negative terminals on the tops of the battery cells 14A-14D. The cell vents 18a-18d may be configured to vent flames originating from the respective battery cell 14A-14D in the event of a thermal runaway condition of the respective battery cell 14A-14D. As also seen therein, the insulator 16₂ may comprise one or more hinged features or hinged elements 20a, 20b configured to align with the cell vents 18a, 18b of battery cells 14A, 14B. Each of the hinged elements 20a, 20b has a closed position and an open position, with the closed positions being depicted in FIG. 2B. In such closed positions, the hinged elements 20a, 20b provide insulation for the battery cells 14A, 14B.

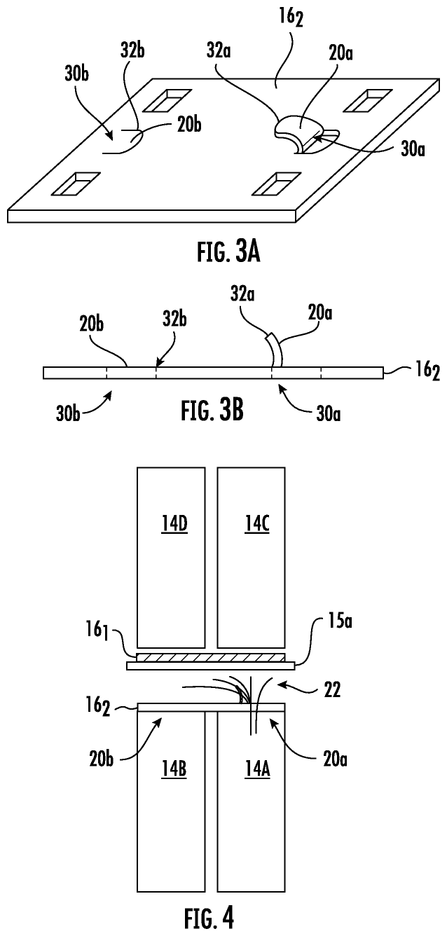

FIGS. 3A and 3B are perspective and cross-sectional views of a non-limiting exemplary embodiment of the insulator 16₂ for the battery system 10 of FIG. 2B according to the present disclosure. FIG. 4 is a side view of a non-limiting exemplary embodiment of the insulator 16₂ for the battery system 10 of FIG. 2B according to the present disclosure. More specifically, FIG. 4 illustrates a cell module in which one of the cells is experiencing a thermal runaway condition. As seen in FIGS. 3A, 3B, and 4, hinged element 20b is shown in a closed position, while hinged element 20a is shown in an open position. In that regard, in the closed position, the hinged element 20b provides insulation for the battery cell 14B and, in the open position, the hinged element 20a provides a vent to enable flames 22 venting from the cell vent (see FIG. 2B) of the battery cell 14A to escape from between the insulator 16₂ and the battery cell 14A. In such a fashion, the present disclosure thereby prevents and/or inhibits the flames 22 venting from the cell vent (see FIG. 2B) of the battery cell 14A from reaching, for example, battery cell 14B.

In that regard, when thermal runaway is triggered in one battery cell (e.g., 14A) for any reason, such as an internal short-circuit, the temperature of such a battery cell will rapidly increase and sometimes cause a fire, the flames of which will escape through the cell vent on the top of such a cell. Thermal runaway of a battery cell may also be trigged by an overheated condition (e.g. >300° C.) of the battery cell. Thus, when thermal runaway occurs in one battery cell, its heat and fire can potentially cause thermal runaway in an adjacent battery cell to be triggered. This may cause the full battery system or pack to catch fire, which can be a very dangerous situation. When one battery cell experiences a thermal runaway condition, it is therefore important to avoid, prevent, and/or inhibit an adjacent battery cell or cells from overheating and being triggered into a thermal runaway condition.

The battery system 10 and insulator 16₂ of the present disclosure are designed to prevent and/or inhibit thermal runaway occurring in one battery cell (e.g., 14A) from propagating to an adjacent battery cell or cells (e.g., 14B). In that regard, the insulators 16₀, 16₁, 16₂, 16₃ may comprise a sheet of aerogel material, a mica plate, or any known insulating material. Once again, the insulators 16₀, 16₁, 16₂, 16₃ may be positioned, provided, located, or interposed between battery cells 14A-14D to insulate the battery cells 14A-14D from heat. The insulators 16₀, 16₁, 16₂, 16₃ may have a thickness (which may be a vertical or horizontal dimension depending on the orientation of the insulator 16₀, 16₁, 16₂, 16₃) in the range of approximately 1.5 to 4 millimeters.

When a defect in battery cell 14A triggers a thermal runaway condition, battery cell 14A may heat up quickly and catch fire. The flames 22 such a fire may then push out through the cell vent 18a on the top of battery cell 14A. Insulator 16₂ is provided, position, or located (and may be fixed) on top battery cell 14A. Insulator 16₂ may include hinged elements 20a, 20b located proximate (e.g., directly above) the cell vents 18a, 18b in battery cells 14A, 14B. As best seen in FIGS. 3A and 3B, each of the hinged elements 20a, 20b is provided or configured with a hinge feature 30a, 30b and a movable edge 32a, 32b and may have a closed position and an open position. When the hinged element 20a, 20b is in the closed position, the movable edge 32a, 32b of the hinged element 20a, 20b has a location adjacent to an edge of a portion of the insulator 16₂. When the hinged element 20a, 20b is in the open position, the moveable edge 32a, 32b of the hinged element 20a, 20b is displaced from the location adjacent to the edge of the portion of the insulator 16₂.

The hinged elements 20a, 20b may be provided with a U-shaped. C-shaped, or V-shaped profile (of any size), or any other profile suitable for enabling the hinged operation described herein. In that regard, hinged features 20a, 20b may be formed by cutting or stamping such a suitable profile from the material of the insulator 16₂, e.g., using a laser cutter. In one embodiment, the material of the insulator 16₂ comprising the hinged feature 20a, 20b is not removed from the insulator 16₂ when the hinged feature 20a, 20b is formed (i.e., to create a through-hole).

When battery cell 14A, for example, experiences a thermal runaway condition and flames 22 exit cell vent 18a, the hinged feature 20a (shown in FIG. 3A as a U-shaped cutout) will be flipped open and pushed out so that the flames 22 can be vented outside of the insulator 16₂ and will not remain but can escape from between the battery cell 14A and the insulator 16₂. In such a fashion, the present disclosure can avoid, prevent, and/or inhibit the flames 22 of such a fire from being kept below the insulator 16₂, which could then spread to an adjacent battery cell, e.g., 14B, underneath the insulator 16₂. Moreover, the hinged element 20b (also shown in FIG. 3A as a U-shaped cutout) above the cell vent 18b of battery cell 14B will remain in place in its closed position, thereby preventing or inhibiting the flames 22 of the fire which have escaped through hinged element 20a in its open position from directly heating adjacent battery cell 14B. Thus, the material of the insulator 16₂ comprising a hinged feature 20a, 20b is a piece of that material that can be pushed away to release flames 22 underneath it, as well as a piece of that material that will remain in place if there is no pressure or flames 22 underneath it so that it can help to stop heat from outside heating up the battery cell over which it is positioned and protecting. In that regard, to realize these functions, rather than hinged features, such pieces of material may alternatively each comprise a dotted-line cut feature wherein most of the material connecting the piece to the greater insulator 16₂ is cut to leave a small portion together such that pressure created by gas or flames 22 venting from a cell vent (e.g., 18b of a battery 14B) could blow (i.e., separate) such a piece off from the insulator 16₂.

Still further, in the event of such a thermal runaway condition occurring in battery cell 14A, insulator 16₁ is positioned, provided, located, or interposed between battery cell 14A in the lower horizontal row and battery cell 14C in the upper horizontal row to prevent or inhibit the heat caused by flames 22 from heating the bottom surface of battery cell 14C too fast. Similarly, insulator 16₃ is positioned, provided, located, or interposed between battery cells 14A and 14B to prevent or inhibit the heat caused by flames 22 from battery cell 14A from heating adjacent battery cell 14B too fast.

In an alternative embodiment, instead of hinged features, small through-holes (e.g., each having an area in the range of approximately 25 to 1600 square millimeters (mm²) of any shape (not shown) may be created in the material of the insulator 16₂ located proximate (e.g., directly above) the cell vents 18a, 18b in battery cells 14A, 14B to enable gas or flames 22 to vent from a battery cell (e.g., 14A) while at the same time being sufficiently small to prevent or inhibit heating of the adjacent battery cell (e.g., 14B) too much through such a hole. In another alternative embodiment, instead of hinged features, dotted-line profiles of any shape (not shown) and size may be created (e.g., laser cut or stamped) in the material of the insulator 16₂ located proximate (e.g., directly above) the cell vents 18a, 18b in battery cells 14A, 14B to create structurally weaker areas in that material such that the material of the insulator 16₂ comprising the profile may be blown out of the insulator 16₂ by a sufficient pressure (e.g., above a threshold) created by gas or flames 22 venting from a battery cell (e.g., 14A), to again avoid, prevent, and/or inhibit the flames 22 of such a fire from being kept below the insulator 16₂, which could then spread to an adjacent battery cell (e.g., 14B) underneath the insulator 16₂. Moreover, the dotted-line profile above another cell vent (e.g., 18b of battery cell 14B) will remain in place, thereby preventing or inhibiting the flames 22 of the fire which have escaped through a blown-out profile from directly heating an adjacent battery cell (e.g., 14B).

Item 1: In one embodiment, the present disclosure provides a battery system comprising a plurality of battery cells each having a cell vent configured to vent flames originating from the battery cell in the event of a thermal runaway condition of the battery cell, and an insulator disposed adjacent a first one of the plurality of battery cells, wherein the insulator comprises a hinged element configured to align with the cell vent of the first one of the plurality of battery cells, the hinged element having a closed position and an open position wherein, in the closed position, the hinged element provides insulation for the first one of the plurality of battery cells and, in the open position, the hinged element provides a vent to enable flames venting from the cell vent of the first one of the plurality of battery cells to escape from between the insulator and the first one of the plurality of battery cells to thereby inhibit the flames venting from the cell vent of the first one of the plurality of battery cells from reaching a second one of the plurality of battery cells.

Item 2: In another embodiment, the present disclosure provides the battery system of Item 1 wherein the insulator comprises a sheet of an insulating material.

Item 3: In another embodiment, the present disclosure provides the battery system of Item 1 or Item 2 wherein the insulator comprises an aerogel or mica plate.

Item 4: In another embodiment, the present disclosure provides the battery system of any of the preceding Items wherein the hinged element is formed from the insulator.

Item 5: In another embodiment, the present disclosure provides the battery system of any of the preceding Items wherein the hinged element has a moveable edge and, when the hinged element is in the closed position, the movable edge of the hinged element has a location adjacent to an edge of a portion of the insulator.

Item 6: In another embodiment, the present disclosure provides the battery system of any of the preceding Items wherein, when the hinged element is in the open position, the moveable edge of the hinged element is displaced from the location adjacent to the edge of the portion of the insulator.

Item 7: In another embodiment, the present disclosure provides the battery system of any of the preceding Items wherein the moveable edge of the hinged element is formed by a cut in the insulator.

Item 8: In another embodiment, the present disclosure provides the battery system of any of the preceding Items wherein the cut in the insulator is formed by a laser.

Item 9: In another embodiment, the present disclosure provides the battery system of any of the preceding Items wherein the moveable edge of the hinged element has a U-shape.

Item 10: In another embodiment, the present disclosure provides the battery system of any of the preceding Items wherein the moveable edge of the hinged element has a V-shape.

Item 11: In another embodiment, the present disclosure provides the battery system of any of the preceding Items wherein the moveable edge of the hinged element has a C-shape.

Item 12: In another embodiment, the present disclosure provides the battery system of any of the preceding Items wherein the second one of the plurality of battery cells is located adjacent the first one of the plurality of battery cells.

Item 13: In another embodiment, the present disclosure provides the battery system of any of the preceding Items wherein the insulator extends over the second one of the plurality of battery cells, wherein the insulator comprises another hinged element configured to align with the cell vent of the second one of the plurality of battery cells, the another hinged element having a closed position and an open position, and wherein, in the closed position, the another hinged element insulates the second one of the plurality of battery cells from the flames venting from the cell vent of the first one of the plurality of battery cells.

Item 14: In another embodiment, the present disclosure provides an insulator for a battery system including a plurality of battery cells, each of the plurality of battery cells having a cell vent configured to vent flames originating from the battery cell in the event of a thermal runaway condition of the battery cell, the insulator comprising a member configured for placement adjacent a first one of the plurality of battery cells, and a hinged element associated with the member and configured to align with the cell vent of the first one of the plurality of battery cells, the hinged element having a closed position and an open position, wherein, in the closed position, the hinged element provides insulation for the first one of the plurality of battery cells and, in the open position, the hinged element provides a vent to enable flames venting from the cell vent of the first one of the plurality of battery cells to escape from between the insulator and the first one of the plurality of battery cells to thereby inhibit the flames venting from the cell vent of the first one of the plurality of battery cells from reaching a second one of the plurality of battery cells.

Item 15: In another embodiment, the present disclosure provides the insulator of Item 14 wherein the member comprises a sheet of an insulating material, the insulating material comprising an aerogel or mica plate.

Item 16: In another embodiment, the present disclosure provides the insulator of Item 14 or Item 15 wherein the hinged element is movable from the closed position to the open position by the flames venting from the cell vent of the first one of the plurality of battery cells.

Item 17: In another embodiment, the present disclosure provides the insulator of any of the preceding Items wherein the hinged element is formed from the member.

Item 18: In another embodiment, the present disclosure provides the insulator of any of the preceding Items wherein the hinged element has a moveable edge and, when the hinged element is in the closed position, the movable edge of the hinged element has a location adjacent to an edge of a portion of the member, and when the hinged element is in the open position, the moveable edge of the hinged element is displaced from the location adjacent to the edge of the portion of the member.

Item 19: In another embodiment, the present disclosure provides the insulator of any of the preceding Items wherein the moveable edge of the hinged element is formed by a cut in the member.

Item 20: In another embodiment, the present disclosure provides the insulator of any of the preceding Items wherein the moveable edge of the hinged element has a U-shape, a V-shape, or a C-shape.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

What is claimed is:

1. A battery system comprising:
a plurality of battery cells each having a cell vent configured to vent flames originating from the battery cell in the event of a thermal runaway condition of the battery cell; and
an insulator disposed adjacent a first one of the plurality of battery cells, wherein the insulator comprises a hinged element configured to align with the cell vent of the first one of the plurality of battery cells, the hinged element having a closed position and an open position;
wherein, in the closed position, the hinged element provides insulation for the first one of the plurality of battery cells and, in the open position, the hinged element provides a vent to enable flames venting from the cell vent of the first one of the plurality of battery cells to escape from between the insulator and the first one of the plurality of battery cells to thereby inhibit the flames venting from the cell vent of the first one of the plurality of battery cells from reaching a second one of the plurality of battery cells.

2. The battery system of claim 1 wherein the insulator comprises a sheet of an insulating material.

3. The battery system of claim 1 wherein the insulator comprises an aerogel or mica plate.

4. The battery system of claim 1 wherein the hinged element is formed from the insulator.

5. The battery system of claim 4 wherein the hinged element has a moveable edge and, when the hinged element is in the closed position, the movable edge of the hinged element has a location adjacent to an edge of a portion of the insulator.

6. The battery system of claim 5 wherein, when the hinged element is in the open position, the moveable edge of the hinged element is displaced from the location adjacent to the edge of the portion of the insulator.

7. The battery system of claim 4 wherein the moveable edge of the hinged element is formed by a cut in the insulator.

8. The battery system of claim 7 wherein the cut in the insulator is formed by a laser.

9. The battery system of claim 5 wherein the moveable edge of the hinged element has a U-shape.

10. The battery system of claim 5 wherein the moveable edge of the hinged element has a V-shape.

11. The battery system of claim 5 wherein the moveable edge of the hinged element has a C-shape.

12. The battery system of claim 1 wherein the second one of the plurality of battery cells is located adjacent the first one of the plurality of battery cells.

13. The battery system of claim 1 wherein the insulator extends over the second one of the plurality of battery cells, wherein the insulator comprises another hinged element configured to align with the cell vent of the second one of the plurality of battery cells, the another hinged element having a closed position and an open position, and wherein, in the closed position, the another hinged element insulates the second one of the plurality of battery cells from the flames venting from the cell vent of the first one of the plurality of battery cells.

14. An insulator for a battery system including a plurality of battery cells, each of the plurality of battery cells having a cell vent configured to vent flames originating from the battery cell in the event of a thermal runaway condition of the battery cell, the insulator comprising:
a member configured for placement adjacent a first one of the plurality of battery cells; and
a hinged element associated with the member and configured to align with the cell vent of the first one of the plurality of battery cells, the hinged element having a closed position and an open position;
wherein, in the closed position, the hinged element provides insulation for the first one of the plurality of battery cells and, in the open position, the hinged element provides a vent to enable flames venting from the cell vent of the first one of the plurality of battery cells to escape from between the insulator and the first one of the plurality of battery cells to thereby inhibit the flames venting from the cell vent of the first one of the plurality of battery cells from reaching a second one of the plurality of battery cells.

15. The insulator of claim 14 wherein the member comprises a sheet of an insulating material, the insulating material comprising an aerogel or mica plate.

16. The insulator of claim 14 wherein the hinged element is movable from the closed position to the open position by the flames venting from the cell vent of the first one of the plurality of battery cells.

17. The insulator of claim 14 wherein the hinged element is formed from the member.

18. The insulator of claim 17 wherein the hinged element has a moveable edge and, when the hinged element is in the closed position, the movable edge of the hinged element has a location adjacent to an edge of a portion of the member, and when the hinged element is in the open position, the moveable edge of the hinged element is displaced from the location adjacent to the edge of the portion of the member.

19. The insulator of claim 18 wherein the moveable edge of the hinged element is formed by a cut in the member.

20. The insulator of claim 18 wherein the moveable edge of the hinged element has a U-shape, a V-shape, or a C-shape.
